(19) United States
(12) Patent Application Publication
(10) Pub. No.: US 2005/0241630 A1
(43) Pub. Date: Nov. 3, 2005

(54) Portable stove

(75) Inventors: Randall L. May, Plano, TX (US); Gary P. Israel, Lantana, TX (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: The Brinkmann Corporation

(21) Appl. No.: 11/118,793

(22) Filed: Apr. 29, 2005

Related U.S. Application Data
(60) Provisional application No. 60/566,903, filed on Apr. 30, 2004.

(51) Int. Cl. A47J 31/00; F24C 5/20

(52) U.S. Cl. 126/38

(57) ABSTRACT

A wind baffle assembly that is configured for use with a stove having a lid pivotably coupled to a bottom housing. The wind baffle assembly includes an upper wind baffle pivotably coupled to the lid, and a lower wind baffle pivotably coupled between the bottom housing and the upper wind baffle.

### CROSS-REFERENCE TO RELATED APPLICATION

Priority is claimed under 35 U.S.C. § 119(e) to U.S. Provisional Patent Application No. 60/566,903, filed on Apr. 30, 2004, entitled “PORTABLE STOVE,” by Randall L. May and Gary P. Israel, which application is incorporated by reference herein.

### BACKGROUND OF THE INVENTION

1. Field of the Invention

The present invention relates generally to the field of portable stoves and, more particularly, to portable stoves having wind baffles.

2. Description of the Related Art

Portable stoves are known generally in the prior art having a rectangular housing that includes a lid and a bottom housing pivotally connected together to fold up into a briefcase-style carrying case for the stove and that also act as a framework for the stove. Such stoves typically include wind baffles that can be erected at opposite ends of the stove to support or brace the lid in an upright position relative to the bottom housing when the lid is open, and to shield the burner flames from the elements. When erected, the wind baffles are typically secured to the lid by hinges, and they are typically secured to the bottom housing by wires, spring clips, or hooks, or simply by resting on the edges of the bottom housing. However, such securing means require the user to undertake additional actions after opening the lid, namely, securing both wind baffles to the bottom housing. Often, the user must use one hand to keep the lid erect while securing at least one wind baffle to the bottom housing. Such securing means also require added attention in cleaning, are prone to breakage, and require additional fabricated and formed parts, adding to the cost.

It should, therefore, be appreciated that there exists a need for a portable stove that provides ease of use, lessens the expense of fabrication, and reduces the risk of breakage. The present invention fulfills these and other needs.

### SUMMARY OF THE INVENTION

Briefly, and in general terms, the invention resides in a portable stove having self-folding wind baffles that unfold as the lid is opened, thereby eliminating the need for the user to secure the wind baffles to the bottom housing in order to support or brace the lid in the open position. More particularly, the invention resides in embodiments of a wind baffle assembly that is configured for use with a stove having a lid pivotably coupled to a bottom housing. The wind baffle assembly includes an upper wind baffle pivotably coupled to the lid, and a lower wind baffle pivotably coupled between the bottom housing and the upper wind baffle.

In other, more detailed features of the invention, the upper wind baffle and the lower wind baffle are generally triangular or trapezoidal in shape. Also, the wind baffle assembly can further include a wind baffle shaft that is configured to couple the upper wind baffle to the lower wind baffle. In addition, the wind baffle assembly can further include an upper wind baffle hinge that is coupled between the lid and the upper wind baffle. Furthermore, the wind baffle assembly can further include a wind baffle support that is coupled between the lid and the upper wind baffle hinge.

When the lid and the bottom housing are folded together in a closed position, the upper wind baffle and the lower wind baffle lie adjacent to one another in a folded position. If a user raises the lid relative to the bottom housing from the closed position to an open position, the wind baffle assembly unfolds and moves into an open position where the wind baffle assembly maintains the lid in an open position relative to the bottom housing. When the wind baffle assembly is in its open position, the user applies a force against the wind baffle assembly to pivot the upper wind baffle relative to the lower wind baffle, and to allow the upper wind baffle and the lower wind baffle to move back into the folded position.

The present invention also resides in a stove that includes the previously discussed bottom housing, lid, and wind baffle assembly. Also, the combination of the wind baffle assembly in its open position, the lid, and the bottom housing define a shielded space, and the combination of the wind baffle assembly in its open position, the lid, and the bottom housing is configured to impede a flow of wind through the shielded space.

The stove can include a handle that is coupled to the lid. Also, the stove can further include a hinge assembly that couples the lid to the bottom housing. In addition, the stove can further include a mid-support board having a raised ridge, which defines a depression in the mid-support board. The mid-support board is configured to rest on the bottom housing. The mid-support board can include a hole, and the lower wind baffle can include a tab that projects through the hole in the mid-support board and that is hingably secured to the mid-support board. Furthermore, the stove can include a grate configured to rest on the mid-support board.

The lid can include a lid front panel, a lid rear panel, a lid first side panel, a lid second side panel, and a lid upper panel. The lid rear panel is spaced apart from, and positioned approximately parallel to, the lid front panel. The lid first side panel is coupled between the lid front panel and the lid rear panel. The lid second side panel is spaced apart from, and positioned approximately parallel to, the lid first side panel, and the lid second side panel is coupled between the lid front panel and the lid rear panel. The lid upper panel is coupled to the lid front panel, the lid rear panel, the lid first side panel, and the lid second side panel. The lid upper panel includes a slope between the lid rear panel and the lid front panel.

The bottom housing can include a housing front panel, a housing rear panel, a housing first side panel, a housing second side panel, and a housing bottom panel. The housing rear panel is spaced apart from, and positioned approximately parallel to, the housing front panel. The housing first side panel is coupled between the housing front panel and the housing rear panel. The housing second side panel spaced apart from, and positioned approximately parallel to, the housing first side panel, and the housing second side panel is coupled between the housing front panel and the housing rear panel. The housing bottom panel is coupled to the housing front panel, the housing rear panel, the housing first side panel, and the housing second side panel. All of the housing front panel, the housing rear panel, the housing first side panel, and the housing second side panel include an upper edge. Each of the upper edges of the housing front panel, the housing rear panel, the housing first side panel, and the housing second side panel include a flange configured to interface with the mid-support board. The housing bottom panel includes a vent.

The stove can further include a burner assembly configured to interface with the mid-support board, and a fuel delivery and ignition system coupled to the bottom housing. The fuel delivery and ignition system is configured to couple to a fuel supply and to interface with the burner assembly. The fuel delivery and ignition system can include the following: a knob frame coupled to the housing front panel; a knob rotatably coupled to the knob frame and configured to regulate the flow of fuel from the fuel supply to the burner assembly; an eduction tube coupled to the bottom housing and configured to interface with the burner assembly and to facilitate the flow of fuel from the fuel supply to the burner assembly; and an electrode coupled to both the bottom housing and the knob, and configured to ignite fuel flowing into the burner assembly. Also, the stove can further include a leg that is coupled to the bottom housing.

The present invention also resides in a stove including a bottom housing, a lid, a mid-support board, a wind baffle assembly, a burner assembly, a fuel delivery and ignition system, and a grate. The lid is pivotably coupled to the bottom housing. The mid-support board is configured to rest on the bottom housing. The wind baffle assembly is coupled between the lid and the mid-support board, and includes an upper wind baffle pivotably coupled to the lid, and a lower wind baffle pivotably coupled between the mid-support board and the upper wind baffle. When the lid and the bottom housing are folded together in a closed position in which the lid and the bottom housing define an interior space, the upper wind baffle and the lower wind baffle lie adjacent to one another in a folded position within the interior space. The burner assembly is coupled to the mid-support board. The fuel delivery and ignition system is coupled to the bottom housing, and configured to couple to a fuel supply and to interface with the burner assembly. The grate is configured to rest on the mid-support board.

For purposes of summarizing the invention and the advantages achieved over the prior art, certain advantages of the invention have been described herein. Of course, it is to be understood that not necessarily all such advantages need to or may be achieved in accordance with any particular embodiment of the invention. Thus, for example, those skilled in the art will recognize that the invention may be embodied or carried out in a manner that achieves or optimizes one advantage or group of advantages without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings. The embodiments are not shown or described in more detail than necessary to explain the invention, and the manner and process of making and using it, by way of example to those skilled in the art.

FIG. 1 is an exploded view of a portable stove in accordance with the invention.

FIG. 2 is a perspective view of the stove of FIG. 1 in a fully open position.

FIG. 3 is a perspective view of the stove of FIG. 1 in a partially open position.

FIG. 4 is a perspective view of the stove of FIG. 1 in a fully closed position.

FIG. 5 is a top plan view of the stove of FIG. 2.

FIG. 6 is a bottom plan view of the stove of FIG. 4.

FIG. 7 is a front elevational view of the stove of FIG. 4.

FIG. 8 is a rear elevational view of the stove of FIG. 4.

FIG. 9 is front elevational view of the stove of FIG. 3.

FIG. 10 is partial cut-away view of the lower wind baffle flange projecting partially through the mid-support board in FIG. 9.

FIG. 11 is a partial sectional view of the lower wind baffle flange curled around the C-shaped rod, taken along the line 11-11 of FIG. 10.

FIG. 12 is right-side elevational view of the stove of FIG. 2.

FIG. 13 is a sectional view of the wind baffle shaft and lower wind baffle and upper wind baffle, taken along the line 13-13 of FIG. 12.

FIG. 14 is sectional view of the wind baffle shaft and lower wind baffle and upper wind baffle, taken along the line of 14-14 of FIG. 13.

FIG. 15 is partial close-up view of the wind baffle hinges of FIG. 9.

### DETAILED DESCRIPTION OF THE PREFERRED EMBODIMENTS

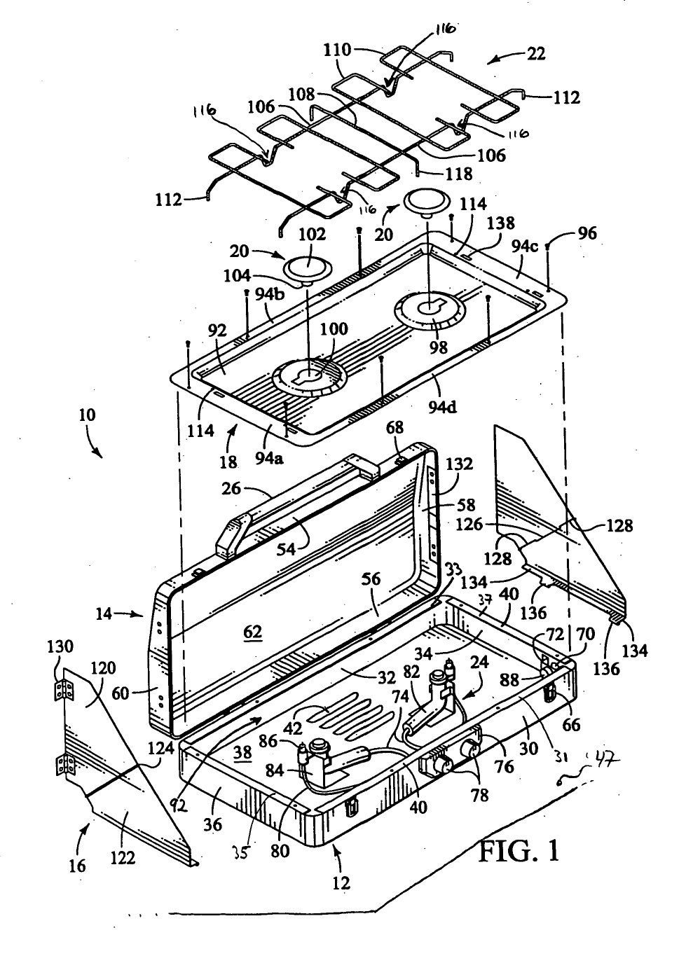

Referring now to the drawings, and particularly to FIGS. 1, 2 and 6, there is shown a portable stove, indicated generally by reference numeral 10, including a bottom housing 12, a lid 14, self-folding wind baffle assemblies 16, a mid-support board 18, burner assemblies 20, a grate 22, a fuel delivery and ignition system 24, and a handle 26. A fuel supply, such as a propane gas canister (not shown), separately may attach to the fuel delivery and ignition system to supply gas for combustion.

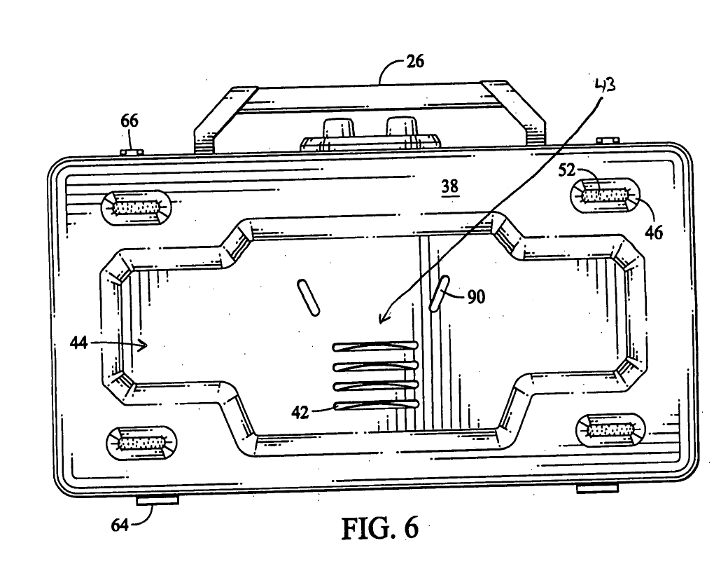

As shown in FIGS. 1, 2 and 6, the bottom housing 12 is generally rectangular in shape, and is formed by a front panel 30, a rear panel 32, two opposed side panels 34 and 36, and a bottom panel 38. The upper edges 31, 33, 35, and 37, respectively, of the front panel, the rear panel and the two opposed side panels of the bottom housing each have an inwardly bent flange 40 to form support brackets for the mid-support board 18. As shown in FIG. 6, the bottom panel of the housing bottom defines a plurality of vents 42, preferably four, generally near the center 43 of the bottom panel, which allows air to circulate into and out of the portable stove 10 and lessening the risk of the portable stove overheating. The bottom panel further includes an inward depression 44, which aids in additional structural support for the bottom housing and provides a preferable mounting height for the burner assemblies 20. The bottom housing can be made from steel, stainless steel, or any other suitable material.

As shown in FIG. 8, preferably, the bottom housing 12 includes four legs 46, which are secured to its bottom panel 38. The legs assist in maintaining the portable stove 10 in a stable position, and prevent the bottom panel from resting directly on a supporting surface 47. Thus, the legs aid in preventing the heat generated by the portable stove from overheating or damaging the surface on which the portable stove rests. The legs are generally rectangular in shape, each leg having a top end 48 and bottom end 50 and including a non-slip pad 52 attached to each bottom end. Preferably, the legs taper downwardly so that the perimeter of the top end is greater than the perimeter of the bottom end. The legs can be made from steel, stainless steel, or any other suitable material.

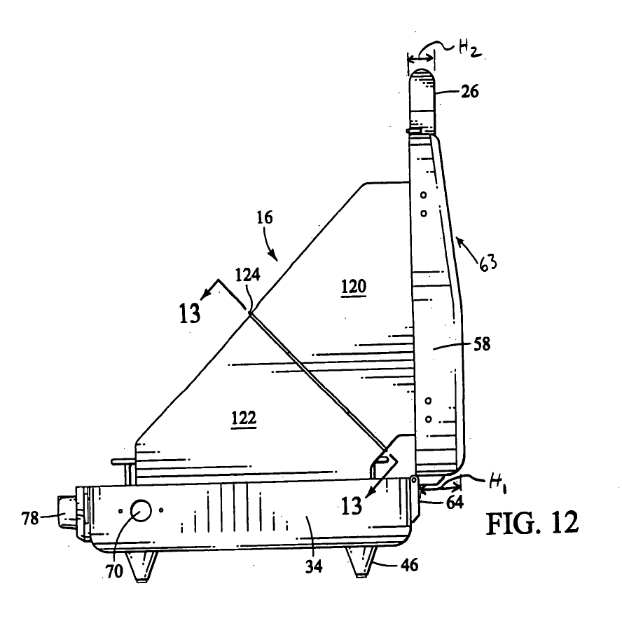

As shown in FIGS. 1, 2, 7, and 8, the lid 14 is generally rectangular in shape, and is formed by a front panel 54, a rear panel 56, two opposed side panels 58 and 60, and an upper panel 62. As shown in FIG. 12, preferably, the upper panel 62 of the lid projects downward from the rear panel to the front panel to define a slope 63, such that the height H₁ of the rear panel is greater than the height H₂ of the front panel. The bottom housing can be made from steel, stainless steel, or any other suitable material.

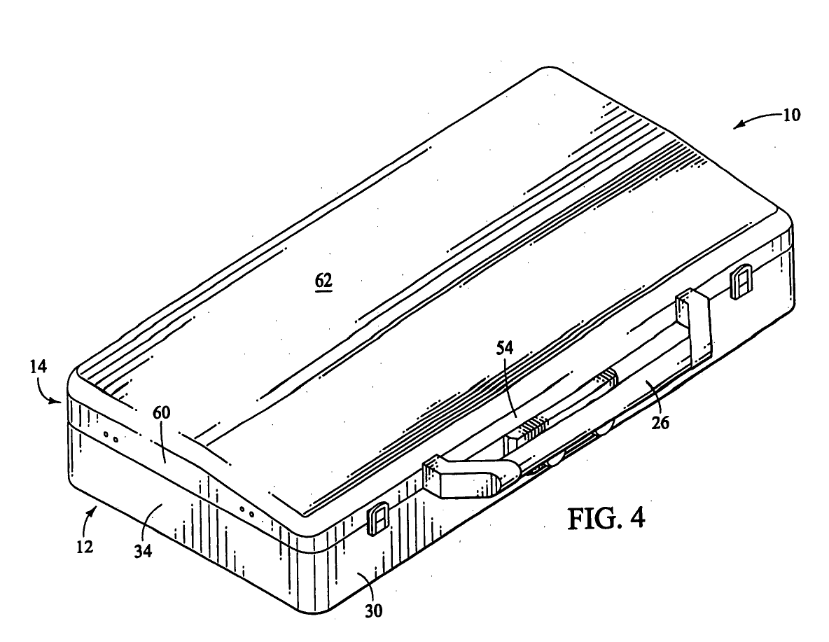

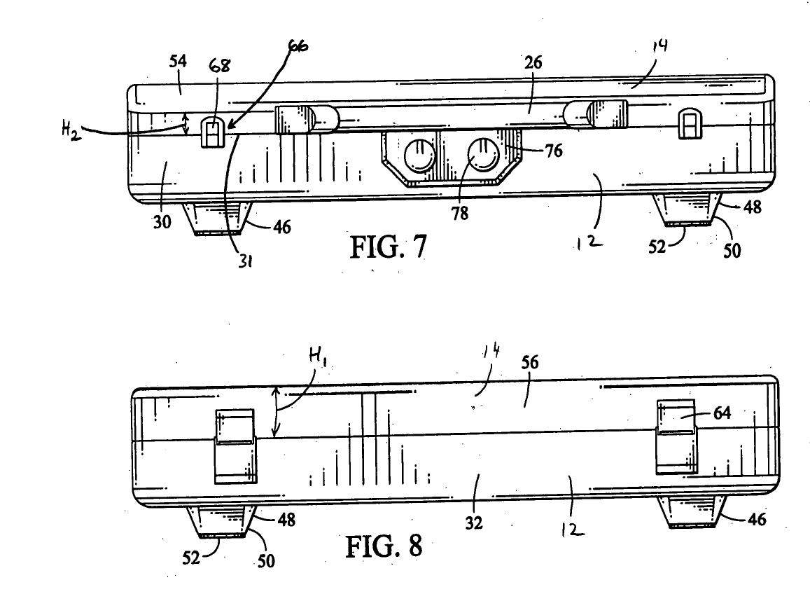

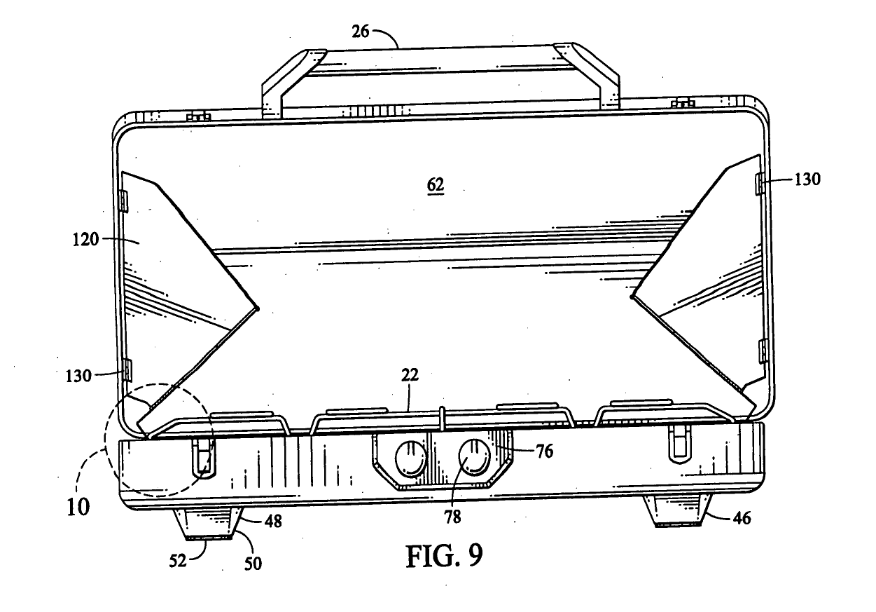

As shown in FIG. 8, the lid 14 and bottom housing 12 are hinged together along the rear panels 56 and 32, respectively, of each housing by a pair of hinge assemblies 64, which permit the lid and the bottom housing to pivot relative to one another, and to be folded together face-to-face into the closed position shown in FIG. 4. Referring to FIG. 7, a pair of latch assemblies 66 is secured to the upper edge 31 of the front panel 30 of the bottom housing, and is disposed to interface with a pair of latch counterparts 68. Thus, securing the lid to the bottom housing in the closed position of FIG. 4, and locking the lid and the bottom housing together for transportation or storage. A handle 26, which is secured to the front panel 54 of the lid, enables a user to pick up and carry the portable stove 10 when the portable stove is in the closed position of FIG. 4.

As illustrated in FIG. 1, the fuel delivery and ignition system 24 is secured to the bottom housing 12 and configured to couple to the fuel supply. The fuel delivery and ignition system includes a hole 70 defined in the bottom housing side panel 34, a gas inlet support bracket 72 secured to the inner wall of the bottom housing side panel and aligned over the hole, a valve assembly (not shown) including a threaded output nozzle (not shown) and feed tubing assembly 74, a lighter box (not shown), a ground line (not shown), a knob frame 76, a pair of knobs 78, a pair of igniters 80, a pair of eduction tubes 82, a pair of eduction tube support assemblies 84, and a pair of spark electrodes 86 configured to ignite fuel output from the fuel supply. It should be recognized that this is an exemplary embodiment configured to support two-burner assemblies, and the fuel delivery and ignition system can be configured to support a different number of burner assemblies.

The gas inlet support bracket 72 includes a hole 88 so that the threaded output nozzle (not shown) is coupled to the gas inlet support bracket through the hole 70 and is positioned to interface with the fuel supply (not shown). The feed tubing assembly 74 extends along the bottom housing 12 to couple to a valve (not shown) and to both the eduction tubes 82 and the knobs 78. The knobs are rotatably mounted to the knob frame 76, which, in turn, is secured to the bottom housing's front panel 30. The knobs are configured to regulate the flow of fuel from the fuel source into the stove. Positioned within the knob frame is the lighter box (not shown) and ground line (not shown). Positioned within the knobs are igniters 80, which extend through a hole (not shown) defined in the knob frame, through an aligned hole (not shown) defined in the bottom housing's front panel, and along the bottom housing to couple to the spark electrodes 86. The eduction tubes are secured to the bottom housing's bottom panel 38 by eduction support assemblies 84. The eduction support assemblies are, in turn, secured to the bottom housing's bottom panel. Referring additionally to FIG. 6, the bottom housing's bottom panel includes holes 90 positioned generally underneath a portion of the eduction tubes 82, which allow air to be drawn into the burner assemblies 20 for proper combustion, and to help cool the interior 92 of the stove 10.

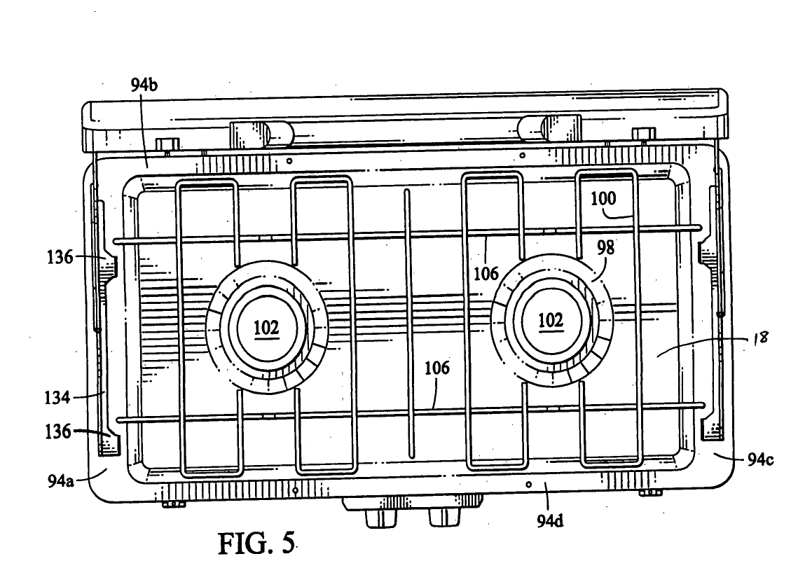

As shown in FIGS. 1 and 5, the portable stove 10 includes a mid-support board 18, which is generally rectangular in shape and sized to interface with the bottom housing 12. The mid-support board assists in preventing food and other matter from clogging or damaging the fuel delivery and ignition system 24, and helps prevent the user from contacting sharp edges that may be present in the interior of the stove. The mid-support board includes a shallow depression 92, which is rectangular in shape and has a smaller perimeter than the mid-support board's outside perimeter, resulting in continuous raised edges 94a-d along the outer perimeter of the mid-support board. The continuous raised edges rest on top of, and are supported by, the bottom housing's flanges 40. The mid-support board is secured to the flanges 40 by a plurality of threaded screws 96 spaced along the continuous raised edges. The width of the continuous raised edges 94a and 94c is greater than the width of the continuous raised edges 94b and 94c.

As shown in FIGS. 1 and 5, the mid-support board 18 further includes a pair of circular raised portions 98, positioned generally above the eduction tubes 82. The circular raised portions 98 are defined by a generally oblong-shaped hole 100, allowing the eduction tubes and spark electrodes 86 to interface with the burner assemblies 20. The burner assemblies are positioned above the mid-support board. In an exemplary embodiment, the burner assemblies include a top cover 102, a bottom cover (not shown) and a holder assembly 104. The holder assembly secures the burner assembly to the eduction tubes. The holder assembly also supports the electric needle box (not shown). The top cover of the burner defines a plurality of holes (not shown) spaced about its circumference to facilitate escape and ignition of gas.

As shown in FIG. 1, the portable stove 10 includes a grate 22 that is configured to rest on the mid-support board. In an exemplary embodiment, the grate includes: two frame members 106, which are parallel to each other and to the bottom housing's front panel 30 and rear panel 32; a third frame member 108, which is perpendicular to the first two frame members 106; and four generally C-shaped frame members 110, which are spaced apart on the two frame members 106. The frame members 106 have frame member ends 112, which bend downward and project through holes 114 defined in raised edges 94a and 94c. The two frame members 106 have depressions 116 which rest on top of the depression 92 of mid-support board 18. The frame member 108 has frame member ends 118 which bend downward and also rest on top of the mid-support board 18. The frame members 106 and 108 and the C-shaped frame members 110 can be made of many different materials, e.g., steel or stainless steel, and can be attached to each other to form an integral unit by known means, e.g., soldering or welding.

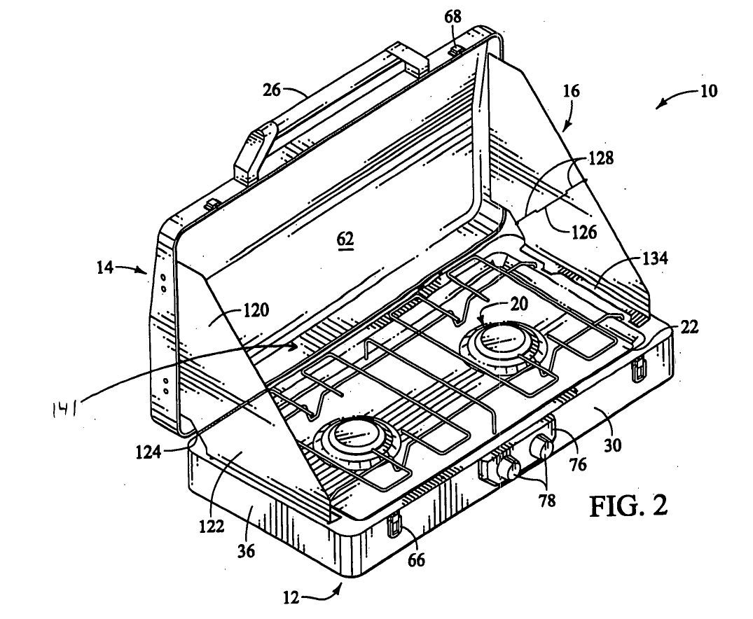

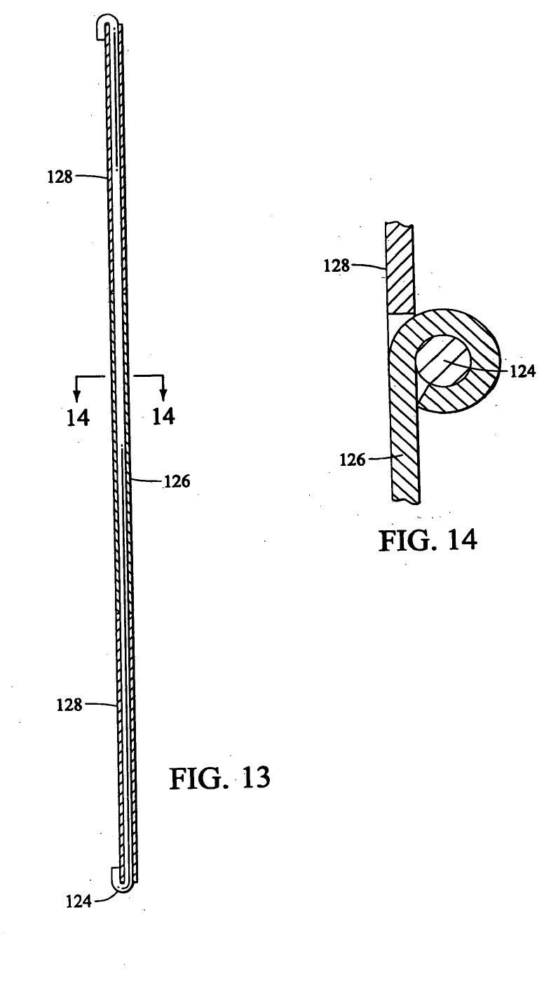

As shown in FIGS. 1 and 2, the portable stove 10 includes two wind baffle assemblies 16 coupled between the lid 14 and the bottom housing 12. For simplicity of discussion, the operation of the wind baffle assemblies will be discussed with reference to a single assembly although the two assemblies operate similarly. In an exemplary embodiment, the wind baffle assembly includes an upper wind baffle 120 and a lower wind baffle 122 pivotably, or hingably, secured together along a common edge by a wind baffle shaft 124. Referring additionally to FIGS. 12-14, the side of the upper wind baffle sharing a common edge with the lower wind baffle including a shallow tab 126 generally near the center of the side, which curls around the wind baffle shaft. The side of the lower wind baffle sharing a common edge with the upper wind baffle including two shallow tabs 128 generally near the outer ends of the side, which curl around the wind baffle shaft. The curled tabs 126 and 128 rotate around the wind baffle shaft 124, resulting in a hinging motion. The wind baffle assembly can be made from many different materials, e.g., steel or stainless steel.

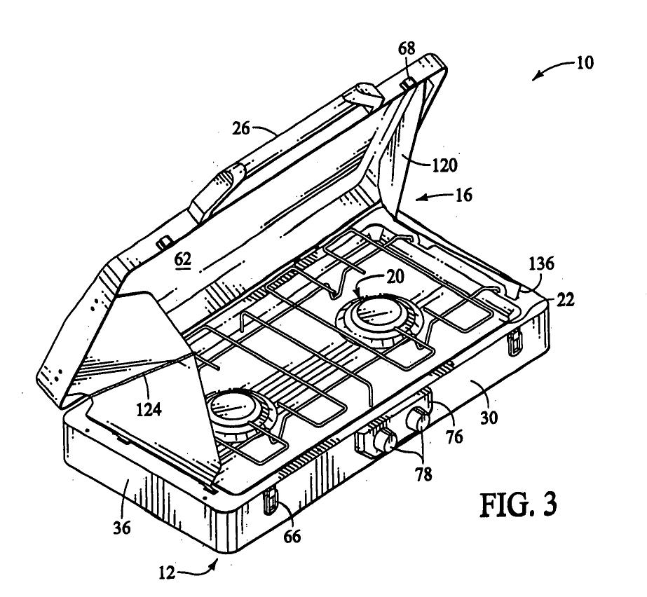

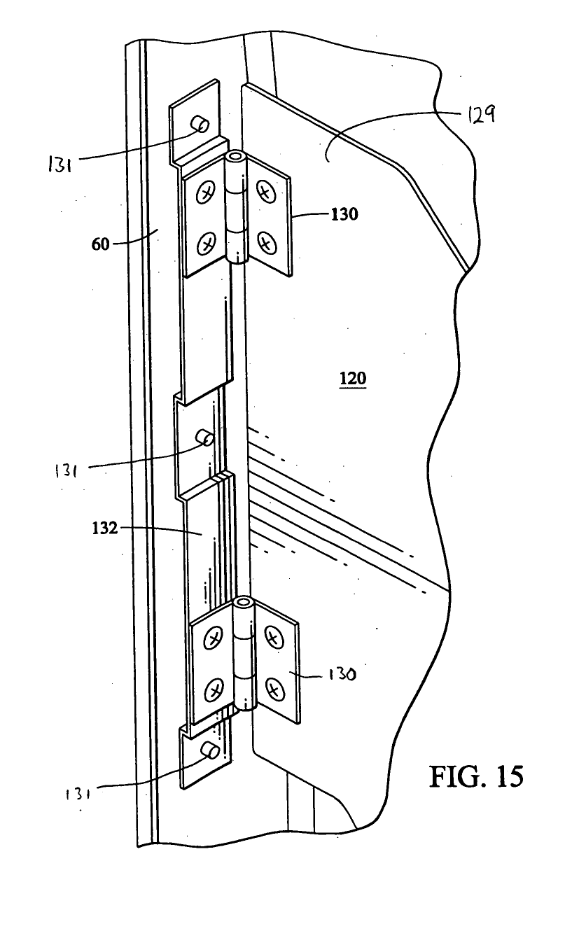

Referring to FIGS. 1 and 3, the upper and lower wind baffles 120 and 122, respectively, are generally irregular in shape but can be best described as generally triangular or trapezoidal. As illustrated in FIG. 15, one side 129 of the upper wind baffle 120 is hingably secured to a pair of wind baffle hinges 130, which, in turn, are secured to a wind baffle support 132. The wind baffle support is secured to the inner wall of the lid's side panels 60 or 58. The upper wind baffle, the wind baffle hinges, and the wind baffle support can be secured by known means 131, e.g., rivets or threaded screws.

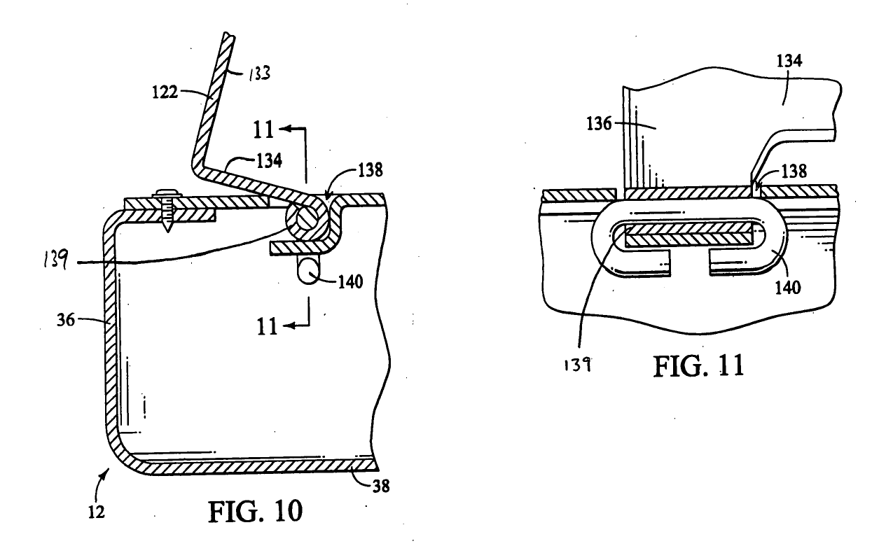

As illustrated in FIGS. 1, 3, and 10-11, one side 133 of the lower wind baffle 122 includes a flange 134 bent inward. The flange includes two protruding tabs 136, which project partially through two holes 138 defined in the continuous raised edge 94a or 94c of the mid-support board 18. A portion 139 of the protruding tabs projects through the mid-support board and curls inward underneath the mid-support board and around a C-shaped rod 140, thus, pivotably, or hingably, securing the wind baffle assembly 16 to the mid-support board.

When the lid 14 and bottom housing 12 are folded together in a closed position, as illustrated in FIG. 4, the upper wind baffle 120 and the lower wind baffle 122 lay flat against each other in a horizontal position within the stove 10 in the interior space formed by the lid and the bottom housing. Advantageously, as a user raises the lid into an open position, as illustrated in FIG. 3, the wind baffle assemblies 16 unfold, and lock into a vertical position, as illustrated in FIG. 2, so that the wind baffle assemblies are positioned perpendicular to the ground or whatever supporting surface 47 the portable stove is resting upon. In the vertical open position, the wind baffle assembly maintains the lid in the open position relative to the bottom housing. Advantageously, once the wind baffle assemblies are unfolded and locked into a vertical position, they prevent the lid from falling down, and into a closed position. A user must exert force inwardly against the wind baffle assembly, preferably near the wind baffle shaft 124, in order to activate the wind baffle assemblies to fold inwards back into a folded position. Advantageously, the combination of the lid, the bottom housing, and the wind baffle assemblies defines a shielded space 141 and impedes the flow of wind through the shielded space.

The present invention has been described above in terms of presently preferred embodiments so that an understanding of the present invention can be conveyed. However, there are other embodiments not specifically described herein for which the present invention is applicable. For example, in other embodiments, the stove is not portable. Therefore, the present invention should not to be seen as limited to the forms shown, which is to be considered illustrative rather than restrictive.

1. A wind baffle assembly that is configured for use with a stove having a lid pivotably coupled to a bottom housing, the wind baffle assembly comprising:
a. an upper wind baffle pivotably coupled to the lid; and
b. a lower wind baffle pivotably coupled between the bottom housing and the upper wind baffle.

2. The wind baffle assembly according to claim 1, wherein the upper wind baffle and the lower wind baffle are generally triangular or trapezoidal in shape.

3. The wind baffle assembly according to claim 1, further comprising a wind baffle shaft that is configured to couple the upper wind baffle to the lower wind baffle.

4. The wind baffle assembly according to claim 1, wherein the wind baffle assembly further includes an upper wind baffle hinge that is coupled between the lid and the upper wind baffle.

5. The wind baffle assembly according to claim 4, further comprising a wind baffle support that is coupled between the lid and the upper wind baffle hinge.

6. The wind baffle assembly according to claim 1, wherein when the lid and the bottom housing are folded together in a closed position, the upper wind baffle and the lower wind baffle lie adjacent to one another in a folded position.

7. The wind baffle assembly according to claim 6, wherein when a user raises the lid relative to the bottom housing from the closed position to an open position, the wind baffle assembly unfolds and moves into an open position where the wind baffle assembly maintains the lid in an open position relative to the bottom housing.

8. The wind baffle according to claim 7, wherein when the wind baffle assembly is in its open position, the user applies a force against the wind baffle assembly to pivot the upper wind baffle relative to the lower wind baffle, and to allow the upper wind baffle and the lower wind baffle to move back into the folded position.

9. A stove comprising:
a. a bottom housing;
b. a lid pivotably coupled to the bottom housing; and
c. a wind baffle assembly coupled between the lid and the bottom housing, the wind baffle assembly including:
i. an upper wind baffle pivotably coupled to the lid, and
ii. a lower wind baffle pivotably coupled between the bottom housing and the upper wind baffle.

10. The stove according to claim 9, wherein the upper wind baffle and the lower wind baffle are generally triangular or trapezoidal in shape.

11. The stove according to claim 9, further comprising a wind baffle shaft that is configured to couple the upper wind baffle to the lower wind baffle.

12. The stove according to claim 9, wherein the wind baffle assembly further includes an upper wind baffle hinge that is coupled between the lid and the upper wind baffle.

13. The stove according to claim 12, further comprising a wind baffle support that is coupled between the lid and the upper wind baffle hinge.

14. The stove according to claim 9, wherein when the lid and the bottom housing are folded together in a closed position in which the lid and the bottom housing define an interior space, the upper wind baffle and the lower wind baffle lie adjacent to one another in a folded position within the interior space.

15. The stove according to claim 14, wherein when a user raises the lid relative to the bottom housing from the closed position to an open position, the wind baffle assembly unfolds and moves into an open position where the wind baffle assembly maintains the lid in an open position relative to the bottom housing.

16. The stove according to claim 15, wherein:
a. a combination of the wind baffle assembly in its open position, the lid, and the bottom housing define a shielded space; and
b. the combination of the wind baffle assembly in its open position, the lid, and the bottom housing is configured to impede a flow of wind through the shielded space.

17. The stove according to claim 15, wherein when the wind baffle assembly is in its open position, the user applies a force against the wind baffle assembly to pivot the upper wind baffle relative to the lower wind baffle, and to allow the upper wind baffle and the lower wind baffle to move back into the folded position.

18. The stove according to claim 9, further comprising a handle coupled to the lid.

19. The stove according to claim 9, wherein the stove further includes a hinge assembly that couples the lid to the bottom housing.

20. The stove according to claim 9, wherein:
a. the stove further includes a mid-support board that includes a raised ridge;
b. the raised edge defines a depression in the mid-support board; and
c. the mid-support board is configured to rest on the bottom housing.

21. The stove according to claim 20, wherein:
a. the mid-support board includes a hole; and
b. the lower wind baffle includes a tab that projects through the hole in the mid-support board and that is hingably secured to the mid-support board.

22. The stove according to claim 20, further comprising a grate configured to rest on the mid-support board.

23. The stove according to claim 20, wherein the lid includes:
a. a lid front panel;
b. a lid rear panel spaced apart from, and positioned approximately parallel to, the lid front panel;
c. a lid first side panel coupled between the lid front panel and the lid rear panel;
d. a lid second side panel spaced apart from, and positioned approximately parallel to, the lid first side panel, and the lid second side panel is coupled between the lid front panel and the lid rear panel; and
e. a lid upper panel coupled to the lid front panel, the lid rear panel, the lid first side panel, and the lid second side panel;
f. wherein the lid upper panel includes a slope between the lid rear panel and the lid front panel.

24. The stove according to claim 20, wherein the bottom housing includes:
a. a housing front panel;
b. a housing rear panel spaced apart from, and positioned approximately parallel to, the housing front panel;
c. a housing first side panel coupled between the housing front panel and the housing rear panel;
d. a housing second side panel spaced apart from, and positioned approximately parallel to, the housing first side panel, and the housing second side panel is coupled between the housing front panel and the housing rear panel; and
e. a housing bottom panel coupled to the housing front panel, the housing rear panel, the housing first side panel, and the housing second side panel;
f. wherein:
i. all of the housing front panel, the housing rear panel, the housing first side panel, and the housing second side panel include an upper edge,
ii. each of the upper edges of the housing front panel, the housing rear panel, the housing first side panel, and the housing second side panel include a flange configured to interface with the mid-support board, and
iii. the housing bottom panel includes a vent.

25. The stove according to claim 24, further comprising:
a. a burner assembly configured to interface with the mid-support board; and
b. a fuel delivery and ignition system coupled to the bottom housing, and configured to couple to a fuel supply and to interface with the burner assembly, the fuel delivery and ignition system including:
i. a knob frame coupled to the housing front panel,
ii. a knob rotatably coupled to the knob frame and configured to regulate a flow of fuel from the fuel supply to the burner assembly,
iii. an eduction tube coupled to the bottom housing and configured to interface with the burner assembly and to facilitate the flow of fuel from the fuel supply to the burner assembly, and
iv. an electrode coupled to both the bottom housing and the knob, and configured to ignite fuel flowing into the burner assembly.

26. The stove according to claim 9, further comprising a leg that is coupled to the bottom housing.

27. A stove comprising:
a. a bottom housing;
b. a lid pivotably coupled to the bottom housing;
c. a mid-support board configured to rest on the bottom housing;
d. a wind baffle assembly coupled between the lid and the mid-support board, the wind baffle assembly including:
i. an upper wind baffle pivotably coupled to the lid, and
ii. a lower wind baffle pivotably coupled between the mid-support board and the upper wind baffle,
iii. wherein when the lid and the bottom housing are folded together in a closed position in which the lid and the bottom housing define an interior space, the upper wind baffle and the lower wind baffle lie adjacent to one another in a folded position within the interior space;
e. a burner assembly coupled to the mid-support board;
f. a fuel delivery and ignition system coupled to the bottom housing, and configured to couple to a fuel supply and to interface with the burner assembly; and
g. a grate configured to rest on the mid-support board.
